(19) United States
(12) Patent Application Publication
(10) Pub. No.: US 2015/0007349 A1
(43) Pub. Date: Jan. 1, 2015

(54) Efficient Assurance of Database Server Integrity

(71) Applicant: Alcatel-Lucent USA Inc., Murray Hill, NJ (US)

(72) Inventors: Vladimir Kolesnikov, Jersey City, NJ (US); Aristeidis Tentes, New York, NY (US)

(73) Assignee: Alcatel-Lucent USA Inc., Murray Hill, NJ (US)

(21) Appl. No.: 13/931,847

(22) Filed: Jun. 29, 2013

(51) Int. Cl. G06F 21/62

(52) U.S. Cl. CPC G06F 21/6209
USPC 726/30

(57) ABSTRACT

An apparatus, e.g. a database verifier, includes an instruction memory and a processor operatively coupled to the instruction memory. The processor is configured by instructions in the memory to verify that a record set is authorized to be transmitted by comparing a received first authenticator value to a calculated second authenticator value determined from the record set and a received verification key.

### TECHNICAL FIELD

The disclosure relates generally to the field of secure storage and retrieval of information.

### BACKGROUND

This section introduces aspects that may be helpful to facilitating a better understanding of the inventions. Accordingly, the statements of this section are to be read in this light and are not to be understood as admissions about what is in the prior art or what is not in the prior art.

The proliferation of malicious software has made it increasingly difficult to ensure the secure retrieval of information from a database server. While various methods have been used to increase security, such methods typically rely on hardening the entities in the data retrieval transaction against malicious attack, e.g. by patching vulnerabilities as they are discovered. This approach is undesirable because it is inherently reactive, and is often expensive to implement.

### SUMMARY

One embodiment provides an apparatus, e.g. a database verifier, that includes an instruction memory and a processor operatively coupled to the instruction memory. The processor is configured by instructions on the memory to verify that a record set is authorized to be transmitted by comparing a received first authenticator value to a calculated second authenticator value determined from the record set and a received verification key.

Another embodiment provides a method, e.g. for verifying a dataset received from a database. The method includes receiving a database record set, a first authenticator value, and a verification key. A second authenticator value is computed from the record set and the verification key. The record set is transmitted only on the condition that the second authenticator value is equal to the first authenticator value.

Yet another embodiment provides a method, e.g. for forming a database verifier. The method includes placing a memory in operable communication with a processor. The memory is configures with instructions adapted to implement a method. The method includes receiving by the processor a database record set, a first authenticator value, and a verification key. A second authenticator value is computed by the processor from the record set and the verification key. The second authenticator value is compared by the processor with the first authenticator value.

In some embodiments the first and second authenticator values are each an aggregated message authentication code (MAC). In some such embodiments the aggregated MAC is a modulo sum of a plurality of MACs each determined for a single record of a database from which the record set is extracted. In some embodiments the instructions are further adapted to configure the processor to transmit the record set only on the condition that the first and second authenticator values are equal. In some embodiments the determination of the second authenticator value by the processor includes computing MAC tokens of each record in the record set, and determining the aggregated MAC from the recomputed MAC tokens. In some embodiments the memory is an unmodifiable memory. In some embodiments the processor is configured to receive the verification key is received via a network path different from the network path over which the database record set is received.

### BRIEF DESCRIPTION OF THE DRAWINGS

A more complete understanding of the present invention may be obtained by reference to the following detailed description when taken in conjunction with the accompanying drawings wherein:

FIG. 1 illustrates a system, e.g. a database retrieval system, that operates consistent with embodiments of the disclosure, including an owner, a server, a client and a verifier;

FIG. 2 illustrates an example database file format that may be used in a database stored on the server of FIG. 1;

FIG. 3 illustrates an example access control policy table associating each entry of the database of FIG. 2;

FIG. 4 illustrates in one embodiment a format of an access control list determined by, e.g. the owner of FIG. 1; and

FIG. 5 illustrates an embodiment of a method, e.g. of accessing data in a secure database system, e.g. the system 100.

### DETAILED DESCRIPTION

The disclosure is directed to, e.g. apparatus, systems and methods for secure storage and retrieval of information from a database server.

Embodiments presented herein describe apparatus and methods to provide improved security of information retrieval from a database. An attacker may attempt to access entries from a database by installing a malicious program on a database server. The malicious program may then access entries of the database and send these to a destination of the attacker's choosing. Some conventional attempts to secure a database rely on detecting the presence of the malicious software, removing the malicious software, and patching the server against future installation of the malicious software. This strategy may be expensive and, worse, sometimes ineffective, as malicious actors continue to seek and exploit vulnerabilities in the server.

Embodiments herein provide improved methods, apparatus and systems for protecting such data by ensuring that a database server can only send data to one or more recipients in an established set of allowed recipients. The database server is constrained to send requested data to a verifier. The verifier utilizes a small nonvolatile memory or hardware-encoded instructions that ensure the verifier cannot be easily compromised. Attempts by the database server to send data to recipients outside this set are detected and blocked by the verifier. In some known database systems, an attacker could succeed by compromising only the database server. For embodiments described herein the attacker would need to compromise both the database server and the verifier to successfully intercept data from the database server. Because the verifier is robust to attack, the likelihood of a successful diversion of data is substantially reduced relative to such known database systems. Moreover, the database held by the database server, as well as other components of the system to access the database, may be modified without any need to modify the verifier. Also, the functions provided by the verifier may be limited to only those needed to receive the data, verify the authority of the recipient, and resend the data, thereby minimizing undesirable performance degradation such as increased latency of data requests.

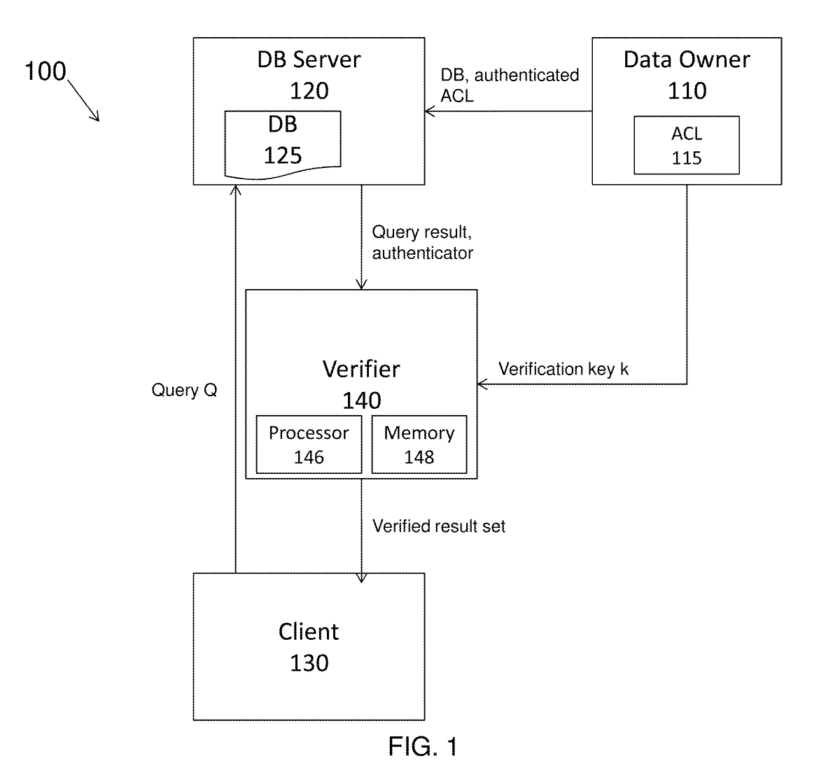

FIG. 1 illustrates a system 100 according to an example embodiment. The system 100 includes a data owner (O) 110, a server (S) 120, a client (C) 130, and a verifier (V) 140. For brevity these entities may be referred to herein simply as the O 110, the S 120, the C 130 and the V 140. Each of the owner 110, server 120 and client 130 may be implemented as a computing apparatus of any appropriate type, e.g. a computing platform including a processor and a memory.

The owner 110 may be a computing device or system under control of an ownership entity with an interest in controlling distribution of data in a database 125 stored by and/or accessible to the server 120. As described further below, the owner 110 provides database data and an authenticated access control list (ACL) 115 to the server 120. The ACL 115 may be accessible to the owner 110 in any manner, e.g. by transient or persistent local storage, or by network access.

In response to a query from the client 130, the server 120 provides a query result to the verifier 140, along with an authenticator value. The verifier 140 determines the validity of the query result, in part using a verification key received from the owner 110. In various embodiments the verification key is a secret key. In the event that the verifier 140 determines that the query result is valid, the verifier 140 provides the query result to the client 130. If instead the verifier 140 determines the query is not valid, then the verifier 140 may block transmission of the result to the client 130.

The verifier 140 may be a small computational entity, e.g. a program, with a limited interface sufficient to receive the requested record from the server 120 and provide the verified record to the client 130. The verifier 140 includes a communications interface (not shown) to, e.g. receive data from the server 120, and transmit data to the client 130. The verifier 140 may be implemented in a general purpose or specialized computing platform, in either case including a processor 146 and an instruction memory 148. A specialized computing platform may include, e.g. a finite state machine or dedicated microcontroller. The instruction memory 148 may be or include a medium that cannot be easily modified, e.g. hardware or read-only memory, to ensure that the verifier 140 cannot be tampered with by a potential attacker.

In various embodiments the verifier 140 receives the verification key from the owner 110 via a different network path than the path over which the verifier 110 receives the query result. In some embodiments the verifier 140 receives verification key directly from the owner 110, e.g. without intermediate reception by another server entity. In particular it may be preferable to prevent the verification key from being transmitted via the database server 120 to prevent the database server 120 from tampering with the verification key. When the verification key is not transmitted via the database server 120, it may be transmitted via a network path different from the network path over which the database record set is received, e.g. as illustrated by the data path from the owner 110 to the verifier 140. Herein and in the claims, the verification key is received “directly” from the owner 110 when the verification key is received via a network path different from the network path over which the database record set is received from the database 120.

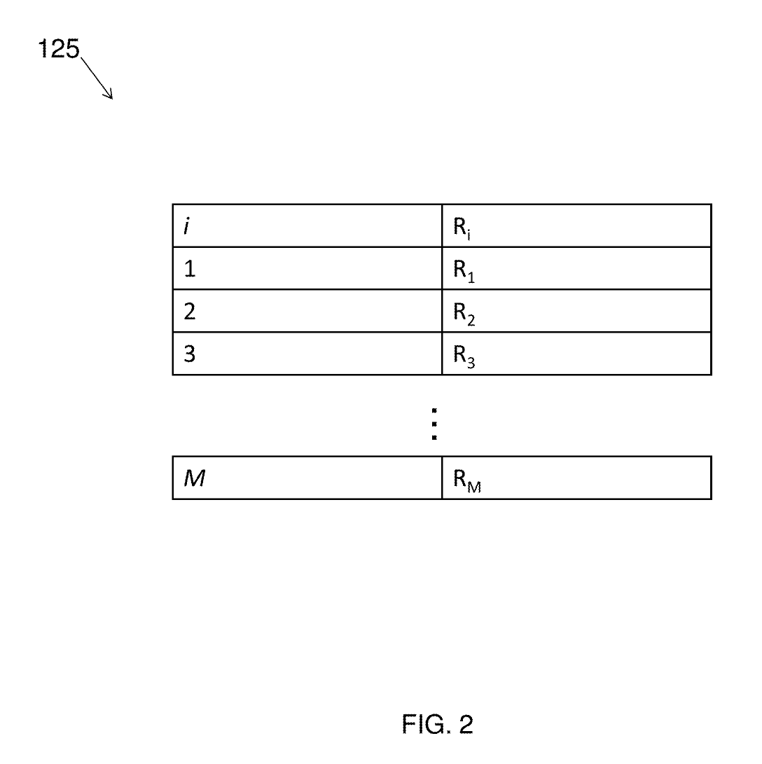

FIG. 2 illustrates in one embodiment a format of the database 125. The database 125 includes a number M of records (or rows) Rᵢ that may be accessed by the server 120 and provided to the verifier 140. The record storage format is not limited to any particular type. In a convenient embodiment, without limitation, the database records Rᵢ are stored in a linear array indexed by i.

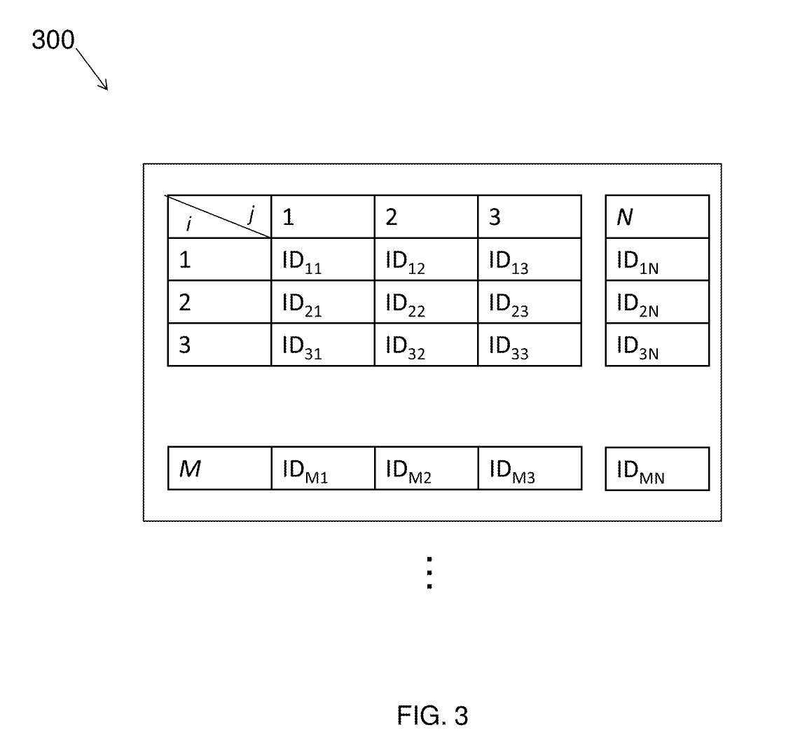

FIG. 3 illustrates an access control policy table 300 associating each entry of the database 125 with a client that is authorized to receive that entry. The table 300 illustrates without limitation a manner in which the owner 110 may associate each database 125 entry with one or more clients authorized to receive that entry. The table 300 includes M rows indexed by i, such that the table 300 may include one row for each of the database 125 entries. Each row of the table 300 includes a number of columns indexed by j. Each of the j columns specifies one client that is permitted to receive the database 125 record indexed by i. Thus, for example, clients represented by ID₁₁, ID₁₂, ID₁₃ . . . ID_{1N} are permitted to receive the record R₁, clients represented by ID₂₁, ID₂₂, ID₂₃ . . . ID_{2N} are permitted to receive the record R₂, and so on. For convenience of presentation all the rows of the ACL table are shown with the same number of entries. However, it is not necessary that each row have the same number of authorized clients. Thus, the maximum value of j will typically be different for the various rows of the table 300.

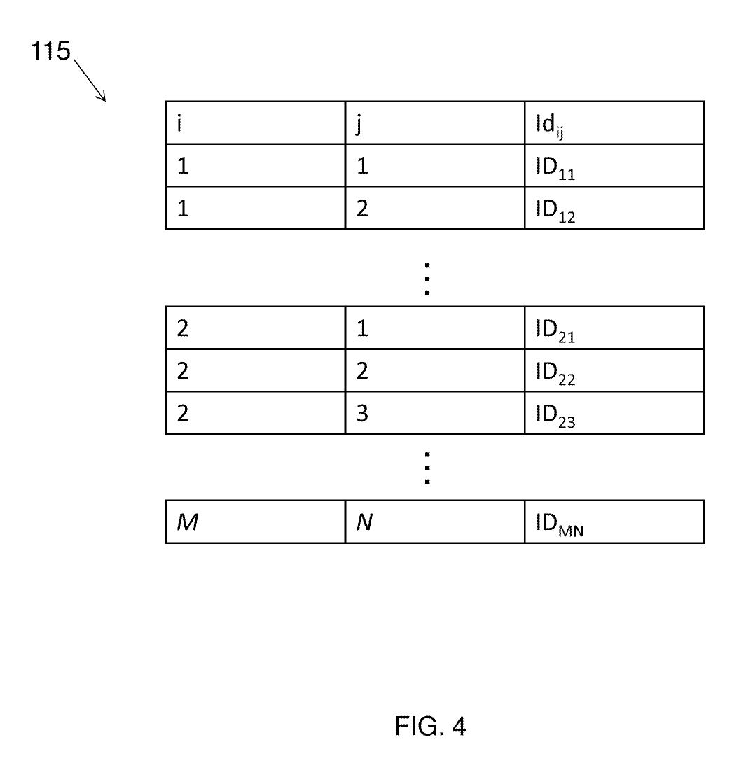

FIG. 4 illustrates in one embodiment a format of the ACL 115. The format is not limited to any particular format. Without limitation in a convenient embodiment the entries are represented by an access right tuple <row i, column j, IDᵢⱼ), where IDᵢⱼ represents one client authorized to access the database entry at row i of the database 125. The presence of a tuple in the ACL 115 indicates that the client with the specified identifier, e.g. the client 130, is allowed to access the database record corresponding to the row i indicated in the tuple. The ACL 115 may include multiple tuples associated with each row of the database 125. In the illustrated example, record R₁ of the database 125 is associated with two clients, and record R₂ is associated with three clients.

In one embodiment for each of the j entries for each row of the ACL 115, the owner 110 determines an ACL token τ, determined as

τᵢⱼ=MACₖ(Rᵢ, IDᵢⱼ),

where k denotes the use of the verification key k in computing each token τ, In this embodiment

The set of all tokens τᵢⱼ constitutes the authenticated ACL, which as previously described is sent to the server 120 by the owner 110. In some embodiments an access control policy may be represented more concisely by the owner 120, but any such representation can of course be converted to the ACL 125 as described above.

When responding to a query by a client with ID equal to the contents of table 300 location ij, the server 120 determines a result set of database entries that meet the parameters of the query. The server 120 authenticates the result set by computing an aggregated MAC of the ACL tokens corresponding to the result set and id. Those skilled in the pertinent art will appreciate that an aggregated MAC, or aMAC, is a technique that aggregates a number of MACs into one small aggregated MAC value, such that the validity may be determined of the constituent MACs represented by the aMAC. Thus, as used herein and in the claims, an aggregated MAC is such a value.

As previously described, the verifier 140 is configured to be substantially impervious to alteration by virtue of its implementation in physically unchangeable features, e.g. hardware-encoded memory. Such implementation is typically significantly more expensive than implementations using transient memory. Thus it may be desirable to limit the size of the verifier 140 by reducing the storage and/or computational demands on the verifier 140. Thus it may not be possible, practical or desirable to store the ACL 115 on the verifier 140.

Instead, the verifier 140 receives the aMAC from the server 120. The verifier 140 may test the validity of the data set received from the server 120 by recomputing the aMAC from the received data set and the verification key received from the owner 110. If the recomputed aMAC is not equal to the aMAC received from the server 120, it may be presumed that at least one of the data in the received set is not authorized to be accessed by the recipient client. The verifier 140 may then block the transmission of all the data in the received data set. While the verifier may not have sufficient information to determine which entries in the received set have been tampered with, blocking delivery of the entire set serves the purpose of ensuring the security of the data in the database.

It is preferable that the aMAC be computed in a manner that provides a high likelihood that alteration of any of the MAC values used to determine the aMAC will result in a modified aMAC value distinguishable from the authentic aMAC value. In a nonlimiting embodiment, the aMAC may be computed by summing the values of the individual aMAC values. In various such embodiments the sum is computed with modulo arithmetic, e.g., modulo an n-bit prime pₙ. In some embodiments n can be selected to be at least 50. In various embodiments the operands of the aMAC computation are limited to tokens specific to the identity of the requester, e.g. a single client Cᵢⱼ. In various embodiments the aMAC is determined as

aMACᵢⱼ=Σ_{i,j} τₖ mod pₙ

where the subscript i denotes that the sum is over all rows of the returned data set, and the subscript j denotes the identity of a single, specific client.

The value of n may conveniently be related to the number of bits of a storage register in the specific implementation of the server 120 and/or the verifier 140. In some cases, n=7, but of course other value of n are possible, and are contemplated by the scope of the disclosure.

In some embodiments the owner 110 may compute the ACL tokens in a manner that results in reduced computational burden on the owner 110 and the verifier 140. In the previously described computation, the tokens τ were determined by summing along each i^{th} database row, incrementing j. In some cases, such as when the number of authorized clients is large for a particular database row, the computation of τ may be computationally expensive. In such cases it may be more efficient to calculate the aMAC along the shorter index i. In such embodiments, the owner 110 and/or may compute the token τᵢ₀=MACₖ(i, Rᵢ) and the tokens τᵢ₁=MACₖ(i, idᵢ₁), τᵢ₂=MACₖ(i, idᵢ₂) . . . τᵢⱼ=MACₖ(i, idᵢⱼ). The owner 110 and the verifier 140 then compute

aMAC_{N}=τᵢ₀+τᵢ₁+τᵢ₂ . . . +τ_{iN} mod pₙ.

The computation of the aMAC, and the underlying MAC values, may be efficiently implemented due to the use of the verification key. This efficiency may reduce the computational complexity of the verifier 140, and therefore reduce the complexity of the physical implementation of the verifier 140. Moreover, because only a single aMAC value is transmitted by the database server 120 to the verifier 140, efficiency of the verification process is significantly enhanced, e.g. by reducing communication overhead.

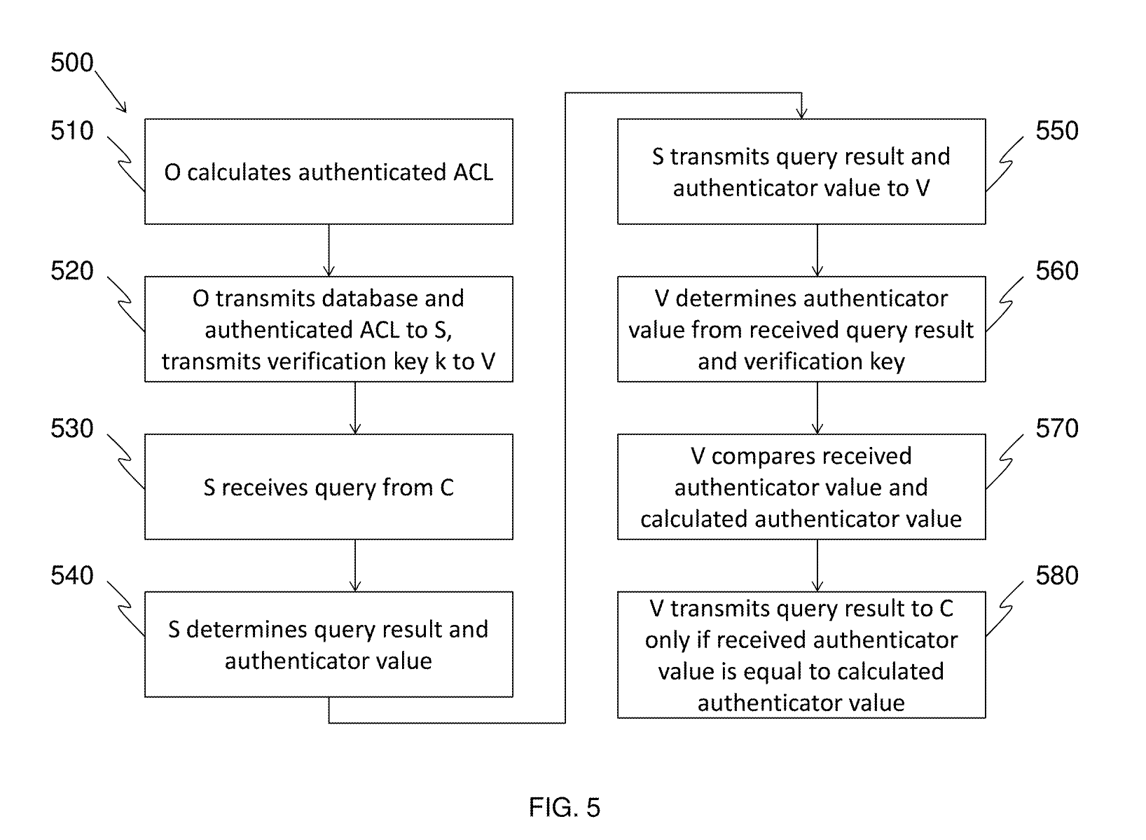

Turning to FIG. 5, a method 500 is presented, e.g. for determining the validity of a database request. The steps of the method 500 are described without limitation by reference to elements previously described herein, e.g. in FIGS. 1-4. The steps of the method 500 may be performed in another order than the illustrated order, and in some embodiments may be omitted altogether and/or performed in parallel or in parallel groups.

In a step 510 a database owner, e.g. the owner 110, determines an authenticated ACL associated with a database, e.g. the database 125. In a step 520 the owner transmits the database and the authenticated ACL to a database server, e.g. the server 120. The owner also transmits to a database query verifier, e.g. the verifier 140, a verification key k used to determine the authenticated ACL. In a step 530 the server receives from a database client, e.g. the client 130, a query for a dataset from the database. In a step 540 the server determines a query result and an authenticator value associated with the dataset, and in a step 550 transmits the query result and authenticator value to the verifier. In a step 560 the verifier determines a verification authenticator value from the received dataset and verification key. In a step 570 the verifier compares the received authenticator value and verification authenticator value. In a step 580 the verifier transmits the dataset to the client only if the received authenticator value is equal to calculated verification authenticator value.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. An apparatus, comprising:
an instruction memory; and
a processor operatively coupled to the instruction memory and configured thereby to verify that a record set is authorized to be transmitted by comparing a received first authenticator value to a calculated second authenticator value determined from the record set and a received verification key.

2. The apparatus of claim 1, wherein the second authenticator value is an aggregated message authentication code (MAC).

3. The apparatus of claim 2, wherein the aggregated MAC is a modulo sum of a plurality of MACs each determined for a single record of a database from which the record set is extracted.

4. The apparatus of claim 1, wherein if the record set is not determined to be authorized the processor blocks transmission of the record set.

5. The apparatus of claim 1, wherein the determination of the second authenticator value by the processor includes computing MAC tokens of each record in the record set, and determining the aggregated MAC from the recomputed MAC tokens.

6. The apparatus of claim 1, wherein the memory is not modifiable.

7. The apparatus of claim 1, wherein the processor is configured to receive the verification key via a network path different from the network path over which the database record set is received.

8. A method, comprising:
receiving a database record set, a first authenticator value, and a verification key; and
computing a second authenticator value from the record set and the verification key; and
transmitting the record set only on the condition that the second authenticator value is equal to the first authenticator value.

9. The method of claim 8, wherein the second authenticator value is an aggregated message authentication code (MAC).

10. The method of claim 9, further comprising computing the aggregated MAC as a modulo sum of a plurality of MACs each determined for a single record of a database from which the record set is extracted.

11. The method of claim 8, wherein the determination of the second authenticator value includes computing MAC tokens of each record in the record set, and determining the aggregated MAC from the recomputed MAC tokens.

12. The method of claim 8, further comprising determining MAC tokens for each database record by indexing over a number of requestors authorized to receive that database record.

13. The method of claim 8, further comprising receiving the verification key via a network path different from the network path over which the database record set is received.

14. A method, comprising:
placing memory in operable communication with a processor;
configuring the memory with instructions adapted to implement a method, the method comprising:
receiving a database record set, a first authenticator value, and a verification key;
computing a second authenticator value from the record set and the verification key; and
comparing the second authenticator value with the first authenticator value.

15. The method of claim 14, wherein the first and second authenticator values are each an aggregated message authentication code (MAC).

16. The method of claim 15, wherein the aggregated MAC is a modulo sum of a plurality of MACs each determined for a single record of a database from which the record set is extracted.

17. The method of claim 14, wherein the instructions are further adapted to configure the processor to transmit the record set only on the condition that the first and second authenticator values are equal.

18. The method of claim 14, wherein the determination of the second authenticator value by the processor includes computing MAC tokens of each record in the record set, and determining the aggregated MAC from the recomputed MAC tokens.

19. The method of claim 14, further comprising configuring the memory as an unmodifiable memory.

20. The method of claim 14, wherein the processor is configured to receive the verification key is received via a network path different from the network path over which the database record set is received.
